(19) United States
(12) Patent Application Publication
(10) Pub. No.: US 2003/0052528 A1
(43) Pub. Date: Mar. 20, 2003

(54) Detachable protective pad for abdominal area

(76) Inventor: Bridgette B. Huggins, Fort Myers, FL (US)

Correspondence Address: FRANK A. LUKASIK, SUITE 142, 1250 W. MARION AVENUE, PUNTA GORDA, FL, 33950, US

(21) Appl. No.: 09/951,825

(22) Filed: Sep. 14, 2001

(51) Int. Cl. B60R 22/14

(52) U.S. Cl. 297/482

(57) ABSTRACT

A reversible, detachable, protective pad which can be attached to seat belt straps to provide protection from either the belt itself or from the dashboard or steering wheel. The pad is constructed with a central cushion having tabs sewn into it which are affixed with a (VELCRO) hook and loop attachment to automobile seat belts.

### BACKGROUND OF THE INVENTION

1. Field of the Invention

This invention relates to seat belt adapters and more particularly to a reversible detachable protective pad which can be attached to seat belt straps so as to provide protection from either the belt itself or from the dashboard or steering wheel.

2. Description of the Prior Art

Various safety devices exist in the prior art which are primarily designed for the protection of occupants of an automobile during emergency situation. Such prior art structures include lap and/or shoulder safety harnesses, cushions, padding, air bags, all of which are generally intended to maintain the occupant of a vehicle within the seat when the vehicle is involved in a collision or comes to an emergency stop or slow down. While some prior art structures such as those disclosed in U.S. Pat. No. 4,610,463 issued to Harriet Efrom Sep. 9, 1986, U.S. Pat. No. 5,005,865 issued to Steinar Kruse Apr. 9, 1991, U.S. Pat. No. 3,936,075 issued to Robert Jelliffe Feb. 3, 1976, U.S. Pat. No. 5,795,030 issued to Karl Becker Aug. 18, 1998 and U.S. Pat. No. 4,575,874 issued to William M. Johnson Mar. 18, 1986, are effectively designed for accomplishing the purpose of protecting the abdominal area of a pregnant woman, none of them are adaptable for protection against the belt itself or, optionally, the steering wheel or dashboard of the vehicle.

This invention provides an inexpensive versatile device, containing suitable padding/cushioning material, which can be alternatively configured as a protective cushion interposed between the abdomen of the user and the seat belt or, between the abdomen and the interior components of the vehicle. The invention is portable and can easily be changed from seat to seat within the vehicle or between vehicles by reason of attachment means comprising (VELCRO) hook and loop components.

### SUMMARY OF THE INVENTION

A preferred embodiment of the present invention, is constructed with a central cushion having tabs sewn into it which are affixed by (VELCRO) hook and loop attachments to automobile seat belts.

It is a primary object of the invention to provide an adjustable portable cushion which can be positioned between the wearer's abdomen and the seat belt or, between the abdomen and the interior components of the vehicle.

It is a further object of the invention to allow for the addition or subtraction of some of the padding within the cushion according to the requirements of individual users.

It is a further object of the invention to provide a choice among different sized cushions according to the requirements of individual users.

It is a further object of the invention to provide a choice of colors and casing materials and to optionally provide imprint areas whereby the device could carry advertising information or thematic decoration as an advertising giveaway item for car companies and other advertisers.

It is a further object of the invention to be adaptable to various safety belt sizes used in automobiles, aircraft or other vehicles.

A soft outer casing is formed from an expandable covering material to encase an inner shell containing padding materials such as cushioning gel or other resilient substances. The outer casing is removable either as a slip cover or through a zippered seam so as to facilitate cleaning of the cover. Interposed between the outer cover and the inner shell is a removable padding material which is used to make overall dimensional adjustments to the unit. Attached to the outer casing are a plurality of “wing like” appendages to which (VELCRO) hook and loop components are attached for fixing the unit in place using the lap seat belt strap. A central loop is attached to secure the unit to the upper seat belt strap.

### BRIEF DESCRIPTION OF THE DRAWINGS

For a more complete understanding of the present invention and the advantages thereof, reference is now made to the detailed description taken in conjunction with the attached drawings in which:

FIG. 1 is a front elevational view partially in section showing typical deployment of the invention.

FIG. 2 is a side elevational view showing a typical deployment of the invention.

FIG. 3 is a from elevational view of the invention showing the attachment means whereby the unit is affixed to seat belts.

FIG. 4 is a front elevational view of the invention partially in section, showing the contents of the device and the layered components which comprise the casings and coverings.

FIG. 5 is a perspective view of a sleeve having an outer covering of loop material and an inner lining of hook material.

### DETAILED DESCRIPTION OF THE PREFERRED EMBODIMENT

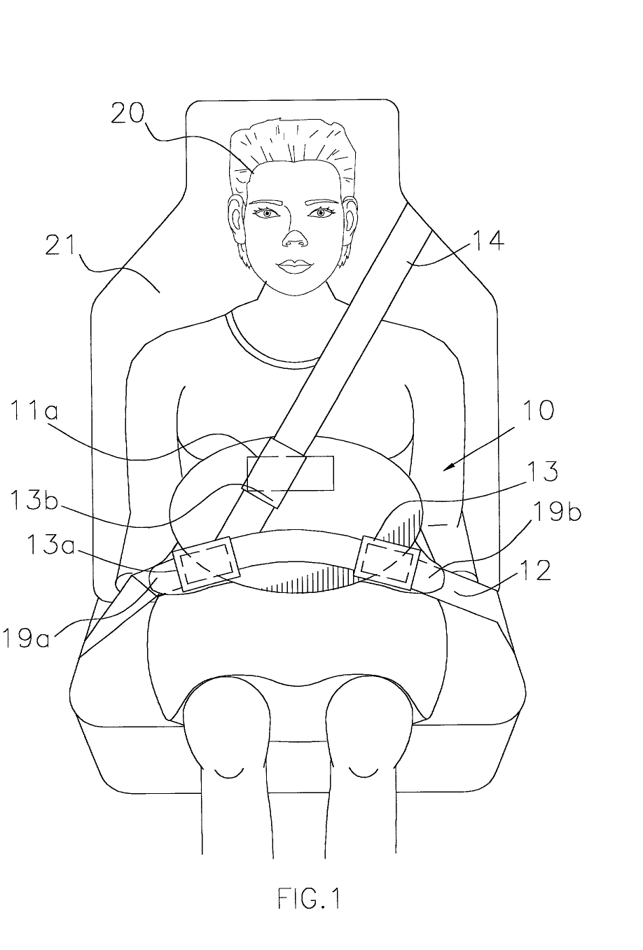

Referring now to the drawings wherein like numerals designate like and corresponding parts throughout the several views, in FIG. 1 the cushion unit is designated overall by the numeral 10. The cushion unit 10 is a padded safety accessory for the seatbelt harness systems of passenger motor vehicles that would make them more comfortable and safer for pregnant women to use. In a preferred embodiment, the cushion unit 10 consists of a cushioned, rubber-covered unit that would attach to the standard vehicle restraint harness by means of (VELCRO) hook and loop. This accessory, cushion unit 10, comprises a padded pillow 11 or pouch-like central piece, that would fit snugly over the woman's 20 stomach. The cushion unit 10 may be attached on the outside or under the vehicle restraint harness depending on the user's choice.

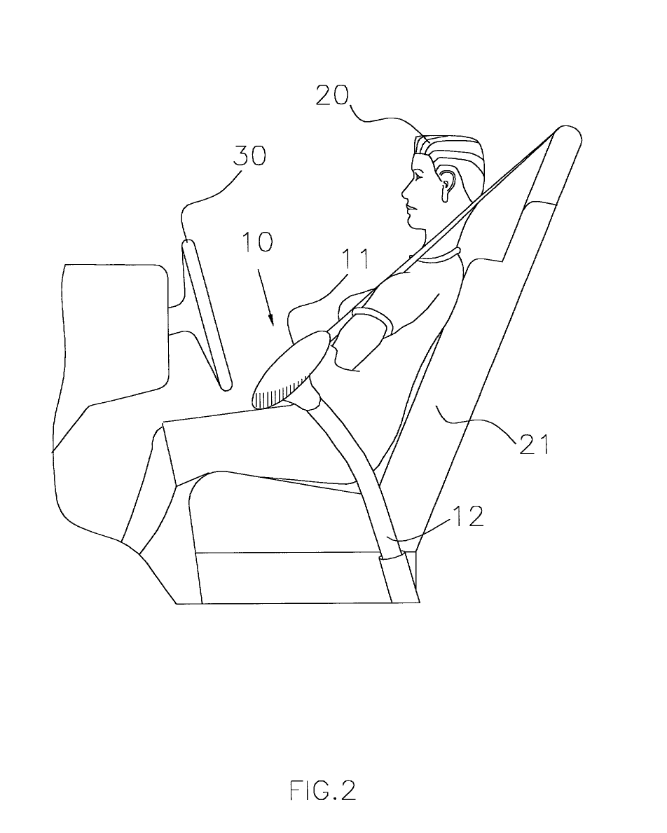

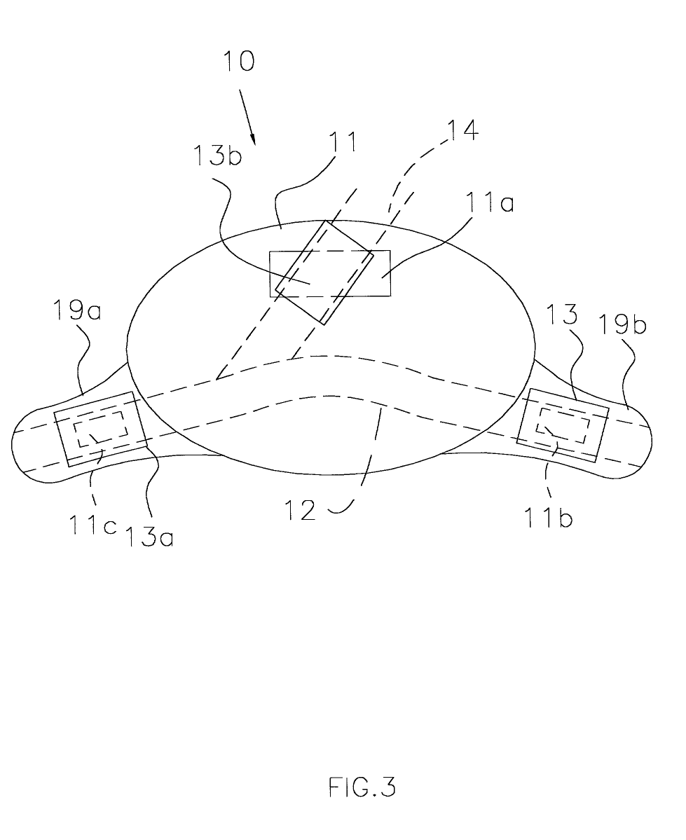

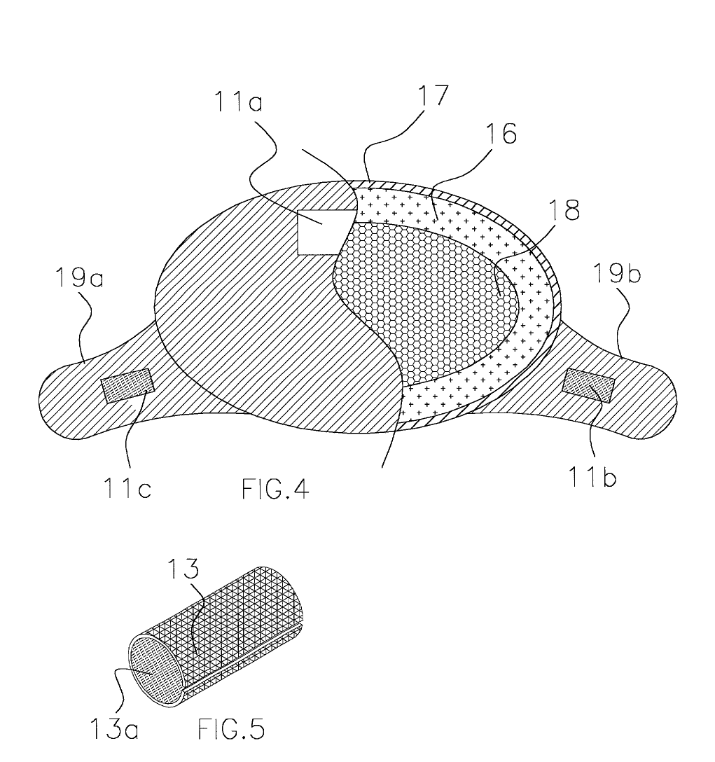

The padded pillow 11 may be formed from a molded, soft to medium, rubber shell 18, encased with a spandex-type material 17 on the outside. The inner liner 16 may be produced from cotton with 2 to 3 inches of cotton padding. A gel insert (not shown) may also be used. Extensions 19a and 19b with loop attachment pieces 11b and 11c would go over or under the lap belt 12. FIG. 1 shows the padded pillow 11 affixed under seat belt 12 and shoulder belt 14. FIGS. 2 and 3 show the cushion unit 10 mounted outside the restraint belts.

FIG. 5 is a perspective view of the sleeves 13, 13a, and 13b in an assembled position. The sleeves are each wrapped around one of the belts 12 or 14 and locked together to form a tube having the hook structure on the outside to merge with and be affixed to the loop attachment pieces 11a, 11b and 11c affixed to the cushion 11.

The cushion unit 10 has been designed to provide pregnant women with a way to make the vehicle restraint system to fit properly without putting pressure on the stomach. In the event of an accident or hard braking of the vehicle, the padding would restrain the woman's torso and would not allow the straps to cut into the body. As a result, no undue force or pressure on the fetus would be caused by the restraint system. The cushion unit 10 may be offered in a range of sizes and colors that would coordinate with vehicle interiors.

What is claimed is:

1. A detachable abdominal cushion for use with seat belts in automobiles, aircraft, and other vehicles as a protection means for pregnant women or persons requiring abdominal protection while traveling in said vehicles, said cushion comprising:
a padded pillow means for fitting snugly over a woman's stomach, said pillow means having an outer surface and an inner surface, and having a first end, a central portion and a second end,
a first extension affixed at said first end and a second extension affixed at said second end,
each of said extensions and said central portion having a loop attachment piece affixed thereto, and
a first and second sleeve slideably mounted on the lap seat belt and a third sleeve slideably mounted on the shoulder belt, each of said sleeves having mating inner and outer hook and loop structures for mating when wrapped around said belts and having an outer hook structure for mating with said loop attachments affixed to said first and second ends and said central portion.

2. A detachable abdominal cushion of claim 1 wherein said pillow means is formed from a molded, soft to medium, rubber shell and encased with a spandex-type material on the outside and said inner liner is produced from cotton in the range from two to three inches.
